(19) United States
(12) Patent Application Publication
(10) Pub. No.: US 2007/0016677 A1
(43) Pub. Date: Jan. 18, 2007

(54) Communication system, and information providing server, information processing device, and program used in such system

(76) Inventors: Kiyotaka Ohara, Nagoya (JP); Makoto Matsuda, North Brunswick, NJ (US); Kazuma Aoki, Kasugai (JP)

Correspondence Address: MCDERMOTT WILL & EMERY LLP, 600 13TH STREET, N.W., WASHINGTON, DC, 20005-3096, US

(21) Appl. No.: 11/480,580

(22) Filed: Jul. 5, 2006

(30) Foreign Application Priority Data
Jul. 5, 2005 (JP) 2005-196297

(51) Int. Cl. G06F 15/173

(52) U.S. Cl. 709/225

(57) ABSTRACT

In a communication system, an information providing server has a request reception unit to receive a request for contents from an information processing device, a content transmission unit to transmit contents corresponding to the received request, and an information addition unit to add related contents to existing contents. The information processing device has a request transmission unit to transmit the request for contents to the information providing server, a content reception unit to receive contents from the information providing server, an addition judgment unit to judge whether the additional information is to be added to the contents, and a restriction unit to restrict request types to those requesting contents relating to the related contents if it is judged that the additional information is to be added to the contents.

### CROSS-REFERENCE TO RELATED APPLICATION

This application claims priority under 35 U.S.C. §119 from Japanese Patent Application No. 2005-196297, filed on Jul. 5, 2005. The entire subject matter of the application is incorporated herein by reference.

### FIELD OF THE INVENTION

Aspects of the present invention relate to a communication system in which an information providing server for providing contents is connected to an information processing device which receives contents from the information providing server.

### BACKGROUND OF THE INVENTION

An Internet connection system, in which an information processing device located on a user side is connected to an information processing device located on a service provider side to provide contents on the Internet for the user's information processing device, has become widespread.

In Japanese Patent Provisional Publication No. HEI 11-69008 (hereafter, referred to as JP HEI 11-69008A), an example of an Internet connection system is disclosed. In the system of JP HEI 11-69008A, an information processing device is configured to detect an interrupt caused by a Catch phoned function (like a call waiting function) implemented on the information processing device so that detection of the interrupt can be notified to a user and the connection to an information providing server of a service provider can be suspended temporarily. When the connection to the server is suspended, the information providing server saves contents to be provided for the information processing device temporarily. The contents saved temporarily in the information providing server is transmitted to the information processing device after the information processing device is connected again to the information providing server.

According to the system disclosed in JP HEI 11-69008A, the user accepts the interrupt made by the Catch phone function, and continues to receive a remaining part of contents after handling the interrupt.

### SUMMARY

An advantage of the present invention is a communication system which enables a user's information processing device to continuously receive contents from an information providing server without being suspended by an interrupt.

### BRIEF DESCRIPTION OF THE ACCOMPANYING DRAWINGS

FIG. 1 is a block diagram of a communication system according to an embodiment of the invention.

FIG. 2 is a flowchart illustrating a multifunction device process executed under control of a multifunction device provided in the communication system of FIG. 1.

FIG. 3 is a flowchart illustrating a polling process.

FIG. 4 is a flowchart illustrating a session process executed by the multifunction device.

FIG. 5 is a flowchart illustrating a UI job executed by the multifunction device.

FIG. 6 is a flowchart illustrating a directory server process executed by a directory server provided in the communication system.

FIG. 7 is a flowchart illustrating a service control information process executed by the directory server.

FIG. 8 is a flowchart illustrating a session process executed by the directory server.

FIG. 9 is a flowchart illustrating a UI job process executed by the directory server.

FIG. 10 is a flowchart illustrating a function server process executed by a function server provided in the communication system.

FIG. 11 is a flowchart illustrating a service control information process executed by the function server.

FIGS. 12 and 13 show a flowchart of a session process executed by the function server.

FIG. 14 is a flowchart illustrating a UI job executed by the function server.

FIG. 15 is a sequence diagram of communications performed between the multifunction device and the directory server and communications performed between the multifunction device and the function server.

FIG. 16 illustrates an example of service definition information.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

According to an aspect of the invention, there is provided a communication system in which an information providing server and an information processing device are connected to each other via a network. The information providing server is provided with a request reception unit to receive a request for contents from the information processing device, a content transmission unit to transmit contents corresponding to the received request to the information processing device, and an information addition unit configured such that, if related contents relating to the contents to be transmitted by the content transmission unit exist, the information addition unit adds addition information, representing presence of the related contents, to the contents to be transmitted by the content transmission unit. The information processing device is provided with a request transmission unit to transmit the request for contents to the information providing server, a content reception unit to receive contents transmitted from the information providing server as a response to the request, an addition judgment unit to judge whether the addition information is added to the contents received by the content reception unit, and a restriction unit to restrict a request to be transmitted by the request transmission unit to request types requesting contents relating to the related contents if the addition judgment unit judges that the addition information is added to the contents from the information providing server.

With this configuration, the information processing device is able to prevent contents other than the related contents from being received if a user wants to receive the related contents. Therefore, it is possible to continue to receive the related contents without interrupted by reception of contents other than the related contents. It is understood that the information providing server may be formed as a single server or may be formed as separate servers respectively providing different contents. The information providing server may be configured to provide contents which have been registered in advance in the information providing server, or may be configured to generate and provide contents in response to the request in accordance with a predetermined procedure.

In at least one aspect of the invention, the restriction unit prohibits requests for contents not relating to the related contents from being transmitted by the request transmission unit.

Such a configuration also makes it possible to restrict a request to be transmitted by the request transmission unit to request types requesting contents relating to the related contents if the addition judgment unit judges that the addition information is added to the contents from the information providing server.

According to another aspect of the invention, there is provided a communication system in which an information providing server and an information processing device are connected to each other via a network. The information providing server is provided with a request reception unit to receive a request for contents from the information processing device, a content transmission unit to transmit contents corresponding to the received request to the information processing device, and an information addition unit configured such that, if related contents relating to the contents to be transmitted by the content transmission unit exist, the information addition unit adds addition information, representing presence of the related contents, to the contents to be transmitted by the content transmission unit. The information processing device is provided with a request transmission unit to transmit the request for contents to the information providing server, a content reception unit to receive contents transmitted from the information providing server as a response to the request, an addition judgment unit to judge whether the addition information is added to the contents received by the content reception unit, and a restriction unit to prohibit requests for contents not relating to the related contents from being transmitted by the request transmission unit if the addition judgment unit judges that the addition information is added to the contents from the information providing server.

With this configuration, the information processing device is able to prevent contents other than the related contents from being received if a user wants to receive the related contents. Therefore, it is possible to continue to receive the related contents without interruption by reception of contents other than the related contents.

In the above mentioned aspects of the invention, the information processing device can be provided with a selection unit to select whether to cause the restriction unit to prohibit requests for contents not relating to the related contents from being transmitted if the addition judgment unit judges that the addition information is added to the contents from the information providing server. In this case, the restriction unit restricts a request to be transmitted by the request transmission unit to request types requesting contents relating to the related contents.

With this configuration, the execution of restriction by the restriction unit is executed only if execution of the restriction is selected. In other words, if execution of the restriction is selected, the information processing device regards such a selection as a request of a user requesting reception of the related contents. Therefore, it is possible to prevent contents other than the related contents from being received by the information processing device.

In the above mentioned aspects of the invention, the addition information can include address information representing an address of the information providing server which transmits the related contents. In this case, the restriction unit restricts a destination of the request transmitted by the request transmission unit to the address represented by the address information.

With this configuration, the information processing device transmits the request to the information providing server for providing the related contents, and to receive the related contents.

According to another aspect of the invention, there is provided an information processing device for receiving contents from an information providing server. The information processing device is provided with a request transmission unit to transmit a request for contents to the information providing server, a content reception unit to receive contents transmitted from the information providing server as a response to the request, an addition judgment unit to judge whether addition information representing presence of related contents relating to the contents to be transmitted by the information providing server is added to the contents received by the content reception unit, and a restriction unit to restrict a request to be transmitted by the request transmission unit to request types requesting contents relating to the related contents if the addition judgment unit judges that the addition information is added to the contents from the information providing server.

With this configuration, the information processing device prevents contents other than the related contents from being received if a user wants to receive the related contents. Therefore, it is possible to continue to receive the related contents without being interrupted by reception of contents other than the related contents.

According to another aspect of the invention, there is provided an information processing device for receiving contents from an information providing server. The information processing device is provided with a request transmission unit to transmit a request for contents to the information providing server, a content reception unit to receive contents transmitted from the information providing server as a response to the request, an addition judgment unit to judge whether addition information representing presence of related contents relating to the contents to be transmitted by the information providing server is added to the contents received by the content reception unit, and a restriction unit to prohibit requests for contents not relating to the related contents from being transmitted by the request transmission unit if the addition judgment unit judges that the addition information is added to the contents from the information providing server.

With this configuration, the information processing device is able to prevent contents other than the related contents from being received if a user wants to receive the related contents. Therefore, it is possible to continue to receive the related contents without being interrupted by reception of contents other than the related contents.

According to another aspect of the invention, there is provided an information providing server for transmitting contents to an information processing device. The information providing server is provided with a request reception unit to receive a request for contents from the information processing device, a content transmission unit to transmit contents corresponding to the received request, and an information addition unit configured such that, if related contents relating to the contents to be transmitted by the content transmission unit exist, the information addition unit adds addition information, representing presence of the related contents, to the contents to be transmitted by the content transmission unit.

Such a configuration of the information providing server enables the information processing device to prevent contents other than the related contents from being received if a user wants to receive the related contents. Therefore, it is possible to continue to receive the related contents without being interrupted by reception of contents other than the related contents.

According to another aspect of the invention, there is provided a computer readable medium comprising computer readable instructions to be executed by a computer, functioning as an information processing device for receiving contents from an information providing server. The instructions cause the computer to transmit a request for contents to the information providing server, to receive contents transmitted from the information providing server as a response to the request, to judge whether addition information representing presence of related contents relating to the contents to be transmitted by the information providing server is added to the contents, and to restrict a request to be transmitted to request types requesting for contents relating to the related contents if it is judged that the addition information is added to the contents from the information providing server.

With this configuration, the information processing device is able to prevent contents other than the related contents from being received if a user wants to receive the related contents. Therefore, it is possible to continue to receive the related contents without interrupted by reception of contents other than the related contents.

According to another aspect of the invention, there is provided a computer readable medium comprising computer readable instructions to be executed by a computer, functioning as an information processing device for receiving contents from an information providing server. The instructions cause the computer to transmit a request for contents to the information providing server, to receive contents transmitted from the information providing server as a response to the request, to judge whether addition information representing presence of related contents relating to the contents to be transmitted by the information providing server is added to the contents, and to prohibit requests for contents not relating to the related contents from being transmitted if it is judged that the addition information is added to the contents from the information providing server.

With this configuration, the information processing device is able to prevent contents other than the related contents from being received if a user wants to receive the related contents. Therefore, it is possible to continue to receive the related contents without being interrupted by reception of contents other than the related contents.

According to another aspect of the invention, there is provided a computer readable medium comprising computer readable instructions to be executed by a computer, functioning as an information providing server for transmitting contents to an information processing device. The instructions cause the computer to receive a request for contents from the information processing device, to transmit contents corresponding to the received request to the information processing device, and to add addition information representing presence of related contents relating to the contents to be transmitted to the contents if the related contents relating to the contents to be transmitted exist.

Such a configuration of the information providing server enables the information processing device to prevent contents other than the related contents from being received if a user wants to receive the related contents. Therefore, it is possible to continue to receive the related contents without being interrupted by reception of contents other than the related contents.

### ILLUSTRATIVE EMBODIMENTS

Hereafter, an illustrative embodiment according to the invention will be described with reference to the accompanying drawings.

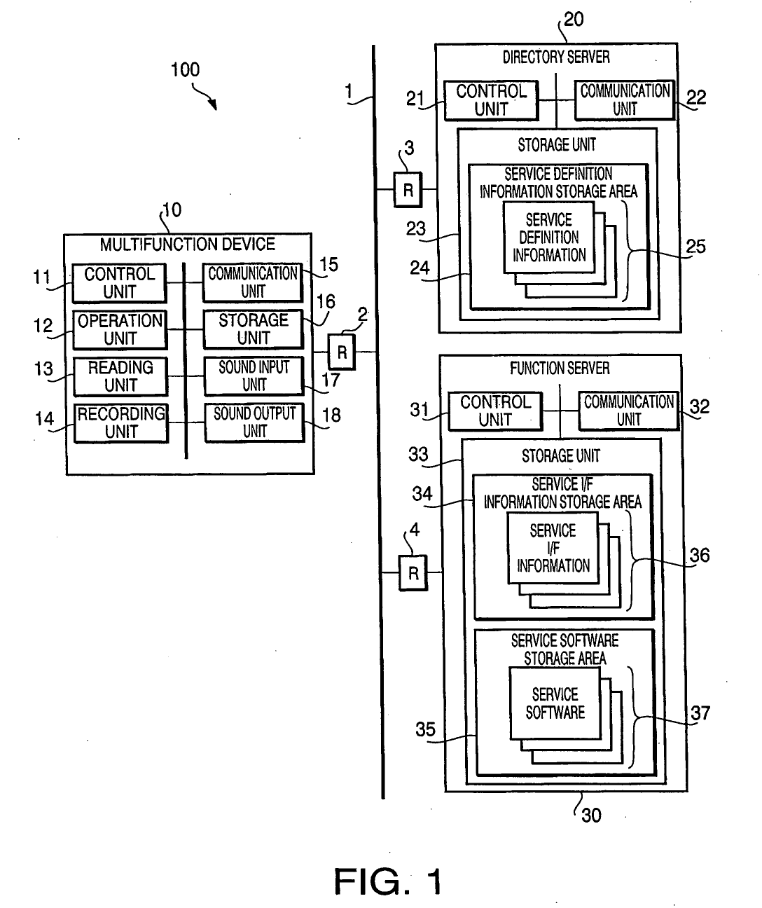

FIG. 1 is a block diagram of a communication system 100 according to an embodiment of the invention. As shown in FIG. 1, the communication system 100 includes a multifunction device (hereafter, abbreviated as MFD) 10, a directory server 20, and a function server 30, which are capable of communicating with each other via a WAN (Wide Area Network) 1. The MFD 10, the directory server 20 and the function server 30 are connected to the network 1 through routers 2, 3 and 4, respectively. The router 2 that intervenes between the MFD 10 and the network 1 may be a broadband router which has a default setting where all the ports are closed and is configured to permit packets matching a connection request issued in the internal network to enter into the internal network after it passes the connection request issued from the internal network to the outside network.

In a normal state (a default setting), the broadband router 2 permits only packets generated on the outside network as responses to a request from the internal network to enter into the internal network, and blocks the other types of packets. The broadband router 2 is thus able to function as a firewall for blocking invalid accesses from the network 1 to the MFD 10.

The MFD 10 has a telephone (voice communication) function, a scanner function, a printing function, a copying function and a facsimile function. In the communication system 100, the MFD 10 is able to receive services concerning the functions implemented therein through the network 1. More specifically, the function server 30 is able to execute more than one kind of service concerning the functions implemented in the MFD 10 in response to a request from the MFD 10.

The directory server 20 is able to provide information concerning available services (which the function server 20 is able to provide) for the MFD 10.

The MFD 10 has a control unit 11, an operation unit 12, a reading unit 13, a recording unit 14, a communication unit 15, a storage unit 16, a sound input unit 17 and a sound output unit 18. The control unit 11 includes a CPU, a ROM, and a RAM, and controls internal components of the MFD 10. In the ROM, programs to be executed by the CPU are stored.

The operation unit 12 includes an operation panel through which a user is able conduct a user operation and information is notified to the user. More specifically, the operation panel has various keys, such as a copy key, a scanner key, a FAX key, a service key, a setting key, direction keys (up, down, left and right keys), an OK key and a cancel key. The operation panel has a display panel on which information is displayed.

The reading unit 13 reads an image formed on a recording medium (e.g., a sheet) to generate image data of the image. The recording unit 14 prints an image corresponding to the image data on a recording medium (e.g., a sheet). The communication unit 15 controls transmission and reception of data to be performed through the network 1. The storage unit 16 has a non-volatile RAM in which various types of data is stored.

The sound input unit 17 has a microphone provided in a handset (not shown), and is able to generate sound data (e.g. PCM data) of sound inputted through the microphone. The sound output unit 18 outputs sound from a speaker provided in the handset or from a speaker attached to a main body of the MFD 10.

The directory server 20 includes a control unit 21, a communication unit 22 and a storage unit 23. The control unit 21 includes a CPU, a ROM, and a RAM, and controls internal components of the directory server 20. In the ROM, programs to be executed by the CPU are stored. The communication unit 12 controls transmission and reception of data to be performed through the network 1. The storage unit 23 has an HDD (Hard Disk Drive) in which information is stored. For example, the storage unit 23 has a service definition information storage area 24 in which service definition information 25 is stored.

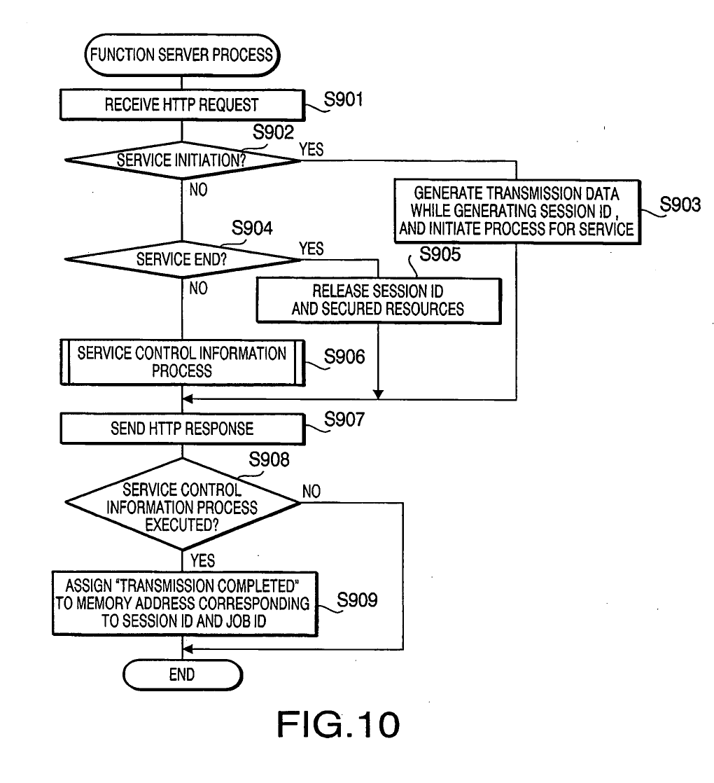

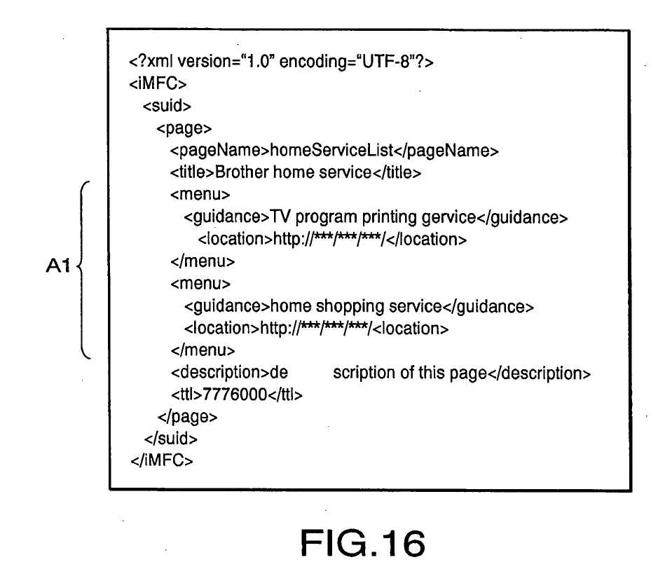

The service definition information 25 contains information (e.g., the type of service and a destination of a service) concerning services that the function server 30 is able to provide. More specifically, the service definition information 25 is represented by SUID (Service User Interface Description). In the description of the service definition information 25, a name of a service type and a URL of a destination of a service are contained (see FIG. 16). In FIG. 16, service types and URLs of desitinations are described in a portion A1. A name of a service type and a URL of a destination of a service can be stored in advance as the service definition information 25 in the service definition information storage area 24 or can be written in the service definition information 25 each time step S802 is processed (see FIG. 9).

By receiving the service definition information 25, the MFD 10 displays a service selection screen, in which service types are described, on the display panel of the MFD 10 to request a user of the MFD 10 to select a service.

The directory server 20 manages services that the function server 30 is able to provide. More specifically, the directory server 20 classifies the services into three categories “Data Storage Service”, “Print Service” and “Copy Application Service”. First, the directory server 20 displays the three categories on the service selection screen to request the user to select one of the categories. Then, the directory server 20 displays services belonging to the selected category to request the user to select one of the services. In the service definition information storage area 24, the service definition information 25 (hereafter, referred to as top service definition information 25) concerning the service selection screen requesting the user to select one of the categories, and two or more pieces of service definition information 25 respectively corresponding to service selection screens (requesting the user to select a service) are stored.

The function server 30 includes a control unit 31, a communication unit 32, and a storage unit 33. The control unit 31 has a CPU, a ROM and a RAM, and controls internal components of the function server 30. In the ROM, various programs to be executed by the CPU are stored. The control unit 31 is considerably higher performance than the control unit 11 of the MFD 10. Therefore, the control unit 31 is able to execute a complicated process which the control unit 11 of the MFD 10 can hardly deal with.

The communication unit 32 controls transmission and reception of data through the network 1. The storage unit 33 includes a hard disk drive in which various types of data are stored. More specifically, the storage unit 33 includes a service interface information storage area 34 in which service interface information 36 is stored, and a service software storage area 35 in which service software 37 is stored.

The service software 37 is used to execute services. In the service software storage area 35, a plurality of types of service software 37 respectively corresponding to various services are stored. The services provided by execution of the service software 37 include a service concerning image data generated by the reading unit 13 of the MFD 10, a service concerning sound data generated by the sound input unit 17 of the MFD 10, a service concerning image data of an image to be printed out by the recording unit 14 of the MFD 10, and a service concerning sound data of sound to be output by the sound output unit 18 of the MFD 10.

The service interface information 36 is used to request parameters required for execution of a service from the MFD 10. By receiving the service interface information 36, the MFD 10 displays a parameter input screen on the display panel of the MFD 10 so as to request the user to make settings of parameters. In the service interface information storage area 34, a plurality of types of service interface information 36 respectively corresponding to services that the function server 30 is able to execute are stored.

For example, in the communication system 100, an HTTP (Hyper Text Transfer Protocol) 1.1 may be used as a protocol for transmission and reception of data between the MFD 10, the directory server 20 and the function server 30. In this case, a message accompanying an HTTP request is used as a command, and a message accompanying an HTTP response to the HTTP request is used as a response to the command.

Hereafter, operations of the MFD 10, the directory server 20 and the function server 30 are described.

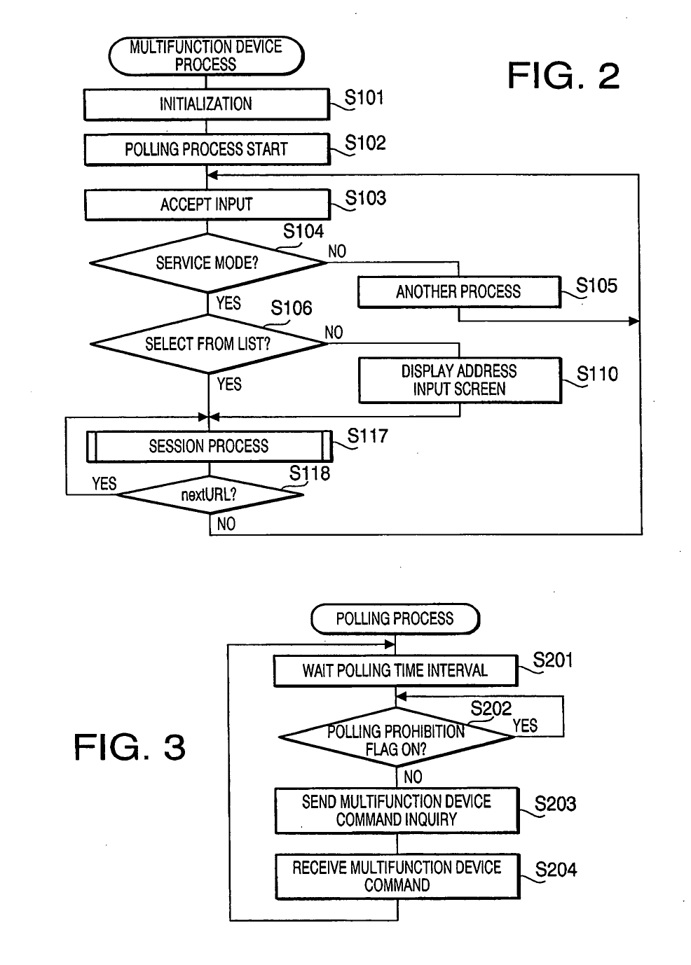

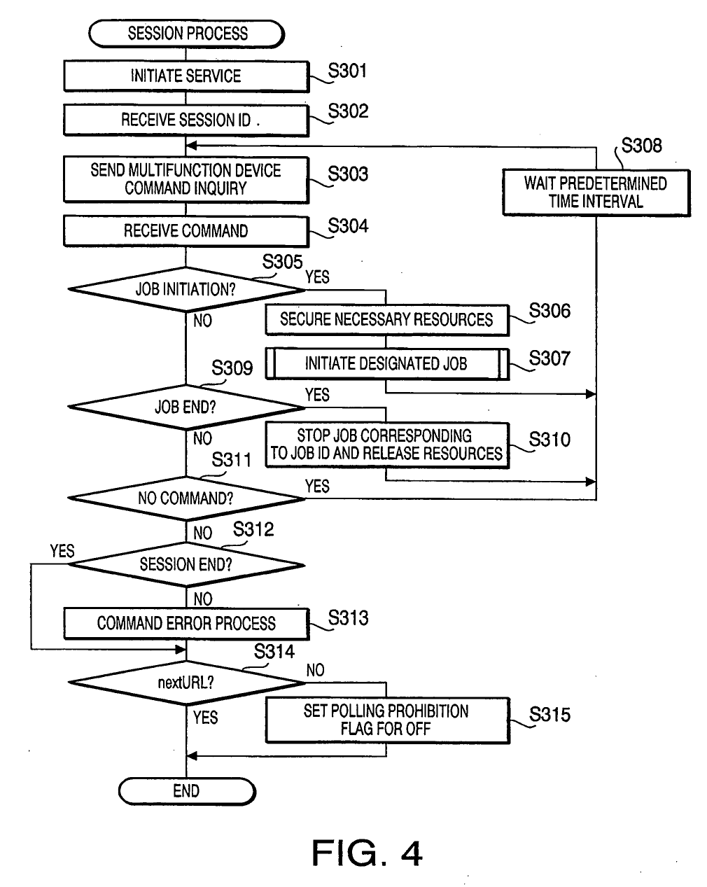

FIG. 2 is a flowchart illustrating a multifunction device process executed under control of the control unit 11 of the MFD 10. The multifunction device process is initiated when the MFD 10 is turned to ON. First, in step S101, the control unit 11 executes an initialization process. Then, the control unit 11 initiates a polling process (see FIG. 3) (step S102). In step S102, the control unit 11 sets a polling prohibition flag indicating prohibition of polling for OFF (i.e., permits polling), and clears a variable “nextURL” representing a destination address (URL) to be accesses next.

In step S103, the control unit 11 accepts an input to the MFD 10. The input to the MFD 10 is a command for causing the MFD 10 to stat a process. For example, the input is a key input conducted through the operation panel or a command transmitted from an external computer through the network 1.

In step S104, the control unit 11 judges whether the input accepted in step S103 is an input for moving to a service mode for requesting for a service from the function server 30. More specifically, the control unit 11 judges whether the input accepted in step S103 is an operation of pressing the service key on the operation panel.

If the input accepted in step S103 is not an input for moving to a service mode (S104: NO), control proceeds to step S105 where the control unit 11 executes another process (e.g., a printing process for an image) corresponding to the input accepted in step S103. Then, control returns to step S103.

If the input accepted in step S103 is an input for moving to a service mode (S104: YES), control proceeds to step S106 where the control unit 11 judges whether a service to be requested from the function server 30 should be selected from a list. More specifically, in step S106, the control unit 11 allows a user to select one of a selection manner of selecting a service from a list and a selection manner of directly inputting a destination URL of a desired service.

If it is judged in step S106 that a service should be selected from a list (S106: YES), control proceeds to step S117. If it is judged in step S106 that a service is not selected from a list (S106: NO), control proceeds to step S110 where the control unit 11 displays an address input screen on the display of the operation panel so as to allow the user to directly input a URL. Then, control proceeds to step S117.

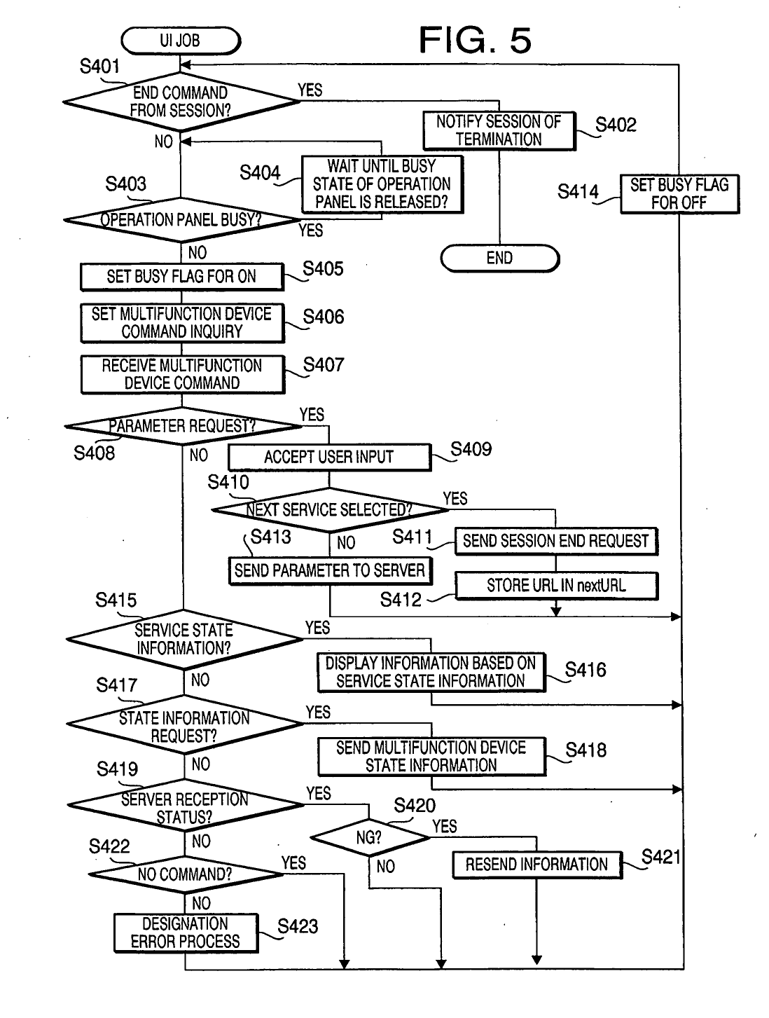

In step S117, a session process (see FIG. 4) is executed. Then, the control unit 11 judges whether the variable “nextURL” has been set. If the variable “nextURL” has been set (S118: YES), control returns to step S117. If the variable “nextURL” has not been set (S118: NO), control returns to step S103.

Next, the polling process initiated in step S102 is described with reference to FIG. 3. First, the control unit 11 waits a predetermined polling interval time (step S201). Then, the control unit 11 judges whether a polling prohibition flag is set (step S202). If the polling prohibition flag is ON (i.e., polling is prohibited) (S202: YES), step S202 is repeated.

If the polling prohibition flag is not ON (S202: NO), the control unit 11 transmits a multifunction device command inquiry, which is an inquiry about a command to the MFD 10, to a URL of a previously designated service. Then, the control unit 11 receives a multifunction device command which represents a command to be handled by the MFD 10 and is retuned as a response to the multifunction device command inquiry (step S204). Then, control returns to step S201.

Hereafter, a session process executed in step S117 is explained with reference to FIG. 4. The session process is executed under control of the control unit 11 of the MFD 10. First, the control unit 11 transmits a service initiation command to a URL of a service to initiate the service (step S301). In step S301, if “nextURL” has been set, the control unit 11 transmits the service initiation command to a URL assigned to “nextURL”. If a service to be used has been selected in a state where no data is set to “nextURL”, the control unit 11 transmits the service initiation command to an address assigned to “Link_Location” of the service definition information 25 (or to an directly inputted URL if a URL is inputted by a user).

Next, in step S302, the control unit 11 receives a session ID identifying a session to be handled from a destination (e.g., the directory server 20 or the function server 30) of the service initiation command. Then, the control unit 11 transmits the multifunction device command inquiry to the destination of the service initiation command (step S303). The session ID received in step S302 is also transmitted to the destination of the service initiation command.

Next, in step S304, the control unit 11 receives a multifunction device command returned as a response to the multifunction device command inquiry. Then, the control unit 11 judges whether a command received in step S304 is a job initiation command (step S305). The job initiation command is a command which the directory server 20 or the function server 30 transmits to notify the MFD 10 of initiation of a job. A job ID and a destination URL of the job are also transmitted to the MFD 10 along with the job initiation command.

If the command received in step S304 is a job initiation command (S305: YES), control proceeds to step S306 where the control unit 11 secures necessary resources. Then, the control unit 11 starts a designated job initiation process (step S307). The designated job is, for example, a user interface job (hereafter, abbreviated as UI job) which is to be executed for a service relating to the operation panel, a scan job which is to be executed for a service relating to image data generated by the reading unit 13, a sound input job which is to be executed for a service relating to sound data generated by the sound input unit 17, a sound output job which is to be executed for a service relating to PCM data outputted by the sound output unit 18, or a print job which is to be executed for a service relating to image data of an image print out by the recording unit 14.

Next, in step S308, the control unit 11 waits a predetermined time interval. Then, control returns to step S303. If it is judged in step S305 that the command received in step S304 is not a job initiation command (S305: NO), control proceeds to step S309 where the control unit 11 judges whether the command received in step S304 is a job end command. The job end command is a command which is transmitted by the directory server 20 or the function server 30 to represent termination of a job. A job ID corresponding to the job to be terminated is also transmitted to the MFD 10 along with the job end command.

If the command is the job end command (S309: YES), control proceeds to step S310 where the control unit 11 terminates the job corresponding to the received job ID and releases the resources. Then, the control unit 11 waits a predetermined time interval (step S308). Then, control returns to step S303.

If it is judged in step S309 that the command is not the job end command (S309: NO), control proceeds to step S311 where the control unit 11 judges whether the command received in step S304 represents “no command”. That is, in step S304, the control unit 11 judges whether a response to the multifunction device command inquiry indicates that there is no command to be handled by the MFD 10.

If the received command represents “no command” (S311: YES), the control unit 11 waits a predetermined time interval (S308). Then, control returns to step S303.

If the received command does not represent “no command” (S311: NO), control proceeds to step S312 where the control unit 11 judges whether the command received in step S304 is a session end command. The session end command is command which is transmitted by the directory server 20 or the function server 30 to represent termination of a session.

If the received command is a session end command (S312: YES), control proceeds to step S314. If the received command is not a session end command, i.e., the command received in step S304 is not the job initiation command, the job end command, the “no command” and the session end command (S312: NO), control proceeds to step S313 where the control unit 11 executes a command error process, for example, by displaying an error message on the display of the operation panel.

Next, the control unit 11 judges whether a URL is assigned to “nextURL” (step S314). If a URL is assigned to “nextURL” (S314: YES), the session process terminates. If a URL is not assigned to “nextURL” (S314: NO), control proceeds to step S315 where the control unit 11 sets the polling prohibition flag for OFF. Then, the session process terminates.

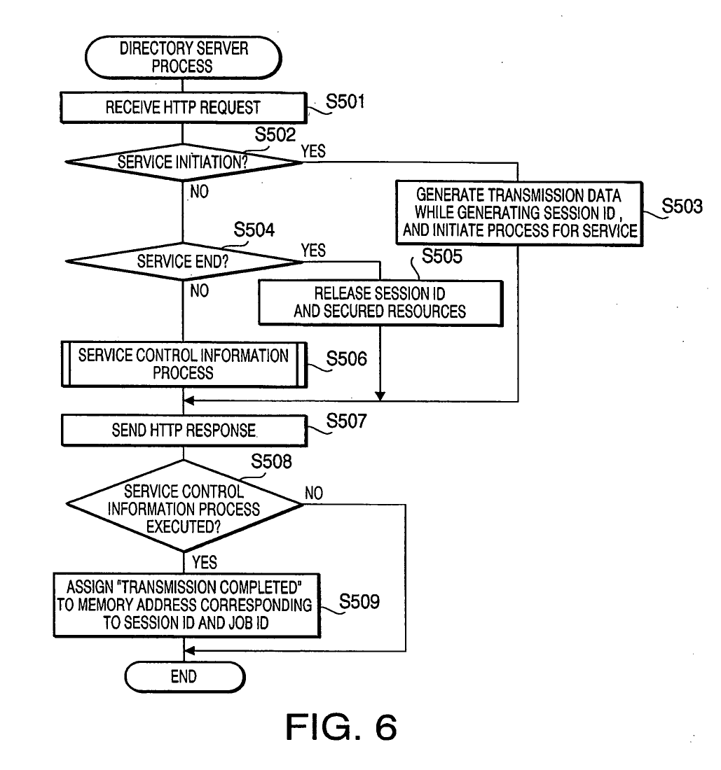

Hereafter, the UI job is explained with reference to FIG. 5. The UI job is executed under control of the control unit 11 of the MFD 10. When the UI job is initiated, the control unit judges whether an end command is issued by a session (step S401). The end command is issued in step S310 of the session process.

If it is judged in step S401 that the end command is issued by the session (S401: YES), control proceeds to step S402 where the control unit notifies the session of termination of a job. Then, the UI job terminates.

If it is judged in step S401 that the end command is not issued by the session (S401: NO), control proceeds to step S403 where the control unit 11 judges whether the operation panel is in a busy state. More specifically, in step S403, the control unit 11 judges that the operation panel is in a busy state when a busy flag (which represents a busy state of the operation panel) is ON, while the control unit 11 judges that the operation panel is not in a busy state when the busy flag is OFF.

If the operation panel is in a busy state (S403: YES), the control unit 11 waits until the busy state of the operation panel is released (step S404). If the operation panel is not in a busy state (S403: NO), control proceeds to step S405 where the control unit 11 sets the busy flag for ON.

Then, the control unit 11 transmits a multifunction device command inquiry to the destination of the service initiation command along with the session ID and the job ID (step S406). Next, in step S407, the control unit 11 receives a multifunction device command returned as a response to the multifunction device job command inquiry.

In step S408, the control unit 11 judges whether the multifunction device command received in step S407 is a parameter request. If the destination of the service initiation command is the directory server 20, the service definition information 25 is transmitted along with the parameter request. If the destination of the service initiation command is the function server 30, the service interface information 36 is transmitted along with the parameter request.

If the multifunction device command is the parameter request (S408: YES), control proceeds to step S409 where the control unit 11 accepts an input operation through the operation panel. If the service definition information 25 is received along with the parameter request, the control unit 11 accepts selection of a service as the input operation. If the service interface information 36 is received along with the parameter request, the control unit 11 accepts parameters as the input operation.

Next, in step S410, the control unit 11 judges whether a next service is selected through the operation panel. If a next service is selected (S410: YES), the control unit 11 transmits a session end request to the directory server 20. Then, the control unit 11 sets a URL of a next service to “nextURL” (step S412), and sets the busy flag for OFF (step S414). Then, control returns to step S401.

If the multifunction device command is not the parameter request (S408: NO), the control unit 11 judges whether the multifunction device command received in step S407 is service state information (step S415). The service state information is transmitted from the function server 30 along with an error code and the service interface information 36.

If the multifunction device command received in step S407 is service state information (S415: YES), the control unit 11 displays information based on the service state information on the display of the operation panel (step S416). Then, control proceeds to step S414 where the control unit 11 sets the busy flag for OFF. Then, control returns to step S401.

If the multifunction device command received in step S407 is not service state information (S415: NO), control proceeds to step S417 where the control unit 11 judges whether the multifunction device command received in step S407 is a state information request. If the multifunction device command received in step S407 is a state information request (S417: YES), the control unit 11 transmits multifunction device state information representing a state of the MFD 10 to the function server 30 (step S418). Then, the control unit 11 sets the busy flag for OFF (step S414). Then, control proceeds to step S401.

If the multifunction device command received in step S407 is not a state information request (S417: NO), control proceeds to step S419 where the control unit 11 judges whether the multifunction device command received in step S407 is a server reception status which is a notification indicating whether the destination of the service initiation command has successfully received information.

If the multifunction device command received in step S407 is a server reception status (S419: YES), control proceeds to step S420 where the control unit 11 judges whether the server reception status represents an abnormal reception (NG). If the server reception status represents an abnormal reception (NG) (S420: YES), control proceeds to step S421 where the control unit 11 re-transmits the previously transmitted information to the destination of the service initiation command. Then, control proceeds to step S414 where the control unit 11 sets the busy flag for OFF. Then, control returns to step S401.

If the server reception status does not represent an abnormal reception (S420: NO), control proceeds to step S414 where the control unit 11 sets the busy flag for OFF. Then, control returns to step S401.

If the multifunction device command received in step S407 is not a server reception status (S419: NO), control proceeds to step S422 where the control unit 11 judges whether the multifunction device command received in step S407 represents “no command”. That is, the control unit 11 judges whether the response to the multifunction device command inquiry transmitted in step S406 indicates that there is no command.

If the multifunction device command received in step S407 represents “no command” (S422: YES), control proceeds to step S414 where the control unit sets the busy flag to OFF. Then, control returns to step S401.

If the multifunction device command received in step S407 does not represent “no command” (S422: NO), control proceeds to step S423 where a process for a designation error is processed. Then, the control unit sets the busy flag to OFF (step S414). Then, control returns to step S401.

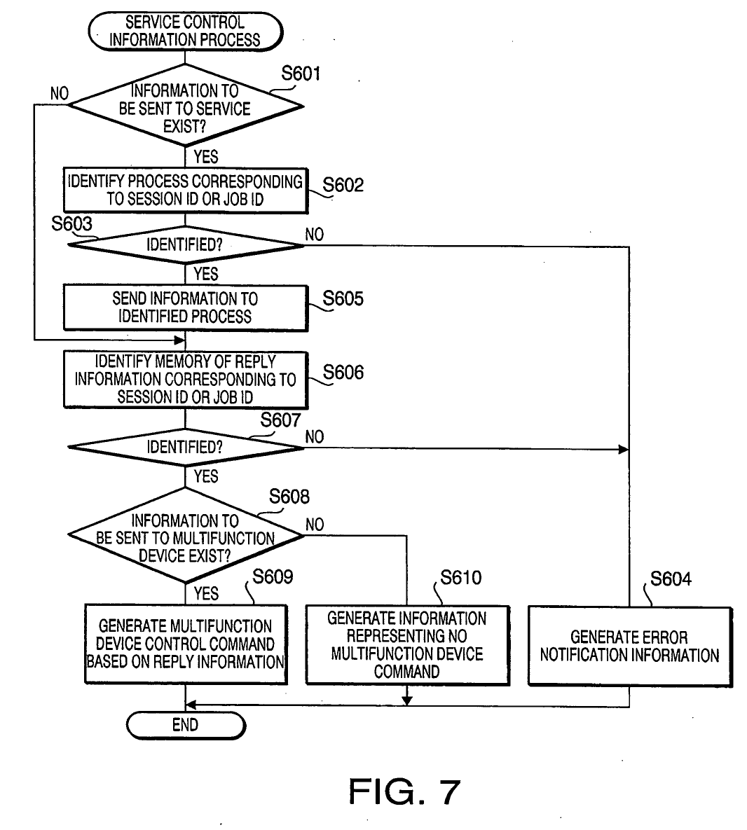

Hereafter, a directory server process to be executed under control of the control unit 21 of the directory server 20 is explained with reference to FIG. 6. The directory server process is initiated when the directory server 20 receives an HTTP request.

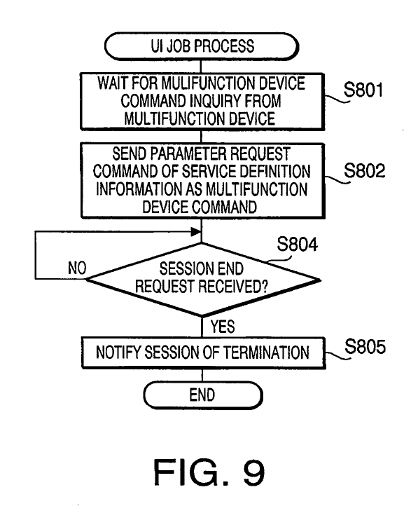

When the directory server process is initiated, the control unit 21 receives an HTTP request in step S501. Then, the control unit 21 judges whether the HTTP request received in step S501 represents a service initiation command. If the control unit 21 judges that the HTTP request received in step S501 represents a service initiation command (S502: YES), control proceeds to step S503 where the control unit 21 generates transmission data while generating a session ID. Further, in step S503, the control unit 21 initiates a process executing a service (i.e., a session process shown in FIG. 8). Then, control proceeds to step S507.

If the control unit 21 judges that the HTTP request received in step S501 does not represent a service initiation command (S502: NO), control proceeds to step S504 where the control unit 21 judges whether the received HTTP request represents a service end command. The service end command is transmitted by the MFD 10, for example, when the MFD 10 accepts an end command from the user of the MFD 10 as an interrupt (e.g., an interrupt made by pressing the cancel key on the display panel).

If the control unit 21 judges that the received HTTP request represents a service end command (S504: YES), control proceeds to step S505 where the control unit 21 releases the session ID and the secured resources. Then, control proceeds to step S507.

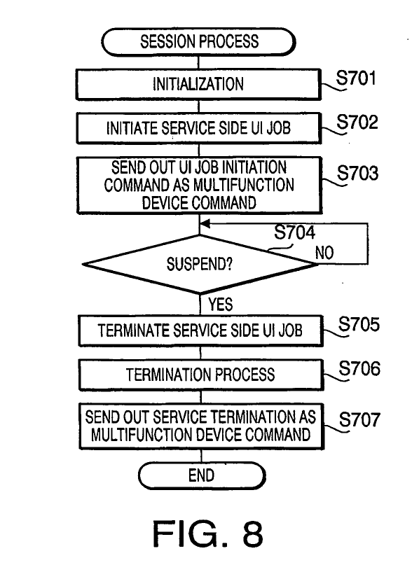

If the control unit 21 judges that the received HTTP request does not represent a service end command (S504: NO), control proceeds to step S506 where a service control information process shown in FIG. 7 is executed. Then, control proceeds to step S507. In step S507, the control unit 21 transmits a response containing generated information.

In step S508, the control unit 21 judges whether the service control information process of step S506 has been executed. If it is judged that the service control information process has been executed (S508: YES), control proceeds to step S509 where the control unit 21 assigns “transmission completed” to a memory address corresponding to the session ID or the job ID. Then, the directory server process terminates. If it is judged that the service control information process has not been executed (S508: NO), the directory server process terminates.

Hereafter, the service control information process to be executed in step S506 of the directory server process (FIG. 6) is explained with reference to FIG. 7.

When the service control information process is initiated, the control unit 21 judges whether information to be sent to a service exists (step S601). More specifically, in step S601, the control unit 21 judges whether the HTTP request received in step S501 contains information to be provided for a service (a session or a job).

If it is judged in step S601 that information to be provided for a service exists (S601: YES), control proceeds to step S602 where the control unit 21 identifies a process corresponding to the session ID or the job ID. That is, the control unit 21 identifies a process which is a destination of the information contained in the received HTTP request. In step S603, the control unit 21 judges whether a process is identified. If a process is not identified due to a certain reason (S603: NO), control proceeds to step S604 where the control unit 21 generates error notification information. Then, the service control information process terminates.

If a process is identified (S603; YES), control proceeds to step S605 where the information is sent to the identified process. Then, control proceeds to step S606. If it is judged in step S601 that information to be provided for a service does not exist (S601: NO), control proceeds to step S606.

In step S606, the control unit 21 identifies a memory area of reply information corresponding to the session ID or the job ID. Next, in step S607, the control unit 21 judges whether the memory area is identified.

If the control unit 21 judges that the memory area is not identified (S607: NO), control proceeds to step S604 where the control unit 21 generates error notification information. Then, the service control information process terminates. If the control unit 21 judges that the memory area is identified (S607: YES), control proceeds to step S608 where the control unit 21 judges whether information to be provided for the MFD 10 exists.

If the information to be provided for the MFD 10 exists (S608: YES), the control unit 21 generates a multifunction device command based on the reply information (step S609). Then, the service control information process terminates.

If the information to be provided for the MFD 10 does not exist (S608: NO), control proceeds to step S610 where the control unit 21 generates information indicating that there is no multifunction device command. Then, the service control information process terminates.

Hereafter, the session process initiated in step S503 of the directory server process (FIG. 6) is explained. When the session process is initiated, the control unit 21 executes an initialization process in step S701. Next, in step S702, the control unit 21 initiates a service side UI job (see FIG. 9). In step S703, the control unit 21 outputs a UI job initiation command as a multifunction command. A job ID and a destination URL are also transmitted along with the UI job initiation command.

In step S704, the control unit 21 judges whether termination is notified by the UI job process. If the control unit 21 is not notified of termination (S704: NO), step S704 is repeated. If the control unit 21 is notified of termination (S704: YES), control proceeds to step S705 where the service side UI job terminates.

Next, in step S706, the control unit 21 executes a termination process (e.g., release of memory). Then, the control unit 21 outputs a multifunction command representing termination of a service (step S707). Then the session process terminates.

Hereafter, a UI job process initiated in step S703 of the session process is explained with reference to FIG. 9. When the UI job process is initiated, the control unit 21 receives a multifunction device command inquiry in step S801. Next, in step S802, the control unit 21 transmits a parameter request command, for requesting the MFD 10 to make settings of parameters (e.g., a URL of a service) required for execution of a service, to the MFD 10 as a multifunction device command. The service definition information 25 stored in the storage unit 23 is also transmitted along with the parameter request.

Next, in step S804, the control unit 21 judges whether the control unit 21 receives a session end request from the MFD 10. The control unit 21 waits until the session end request is received (S804: NO). If the session end request is received (S804: YES), the control unit 21 terminates the session (step S805). Then, the UI job process terminates.

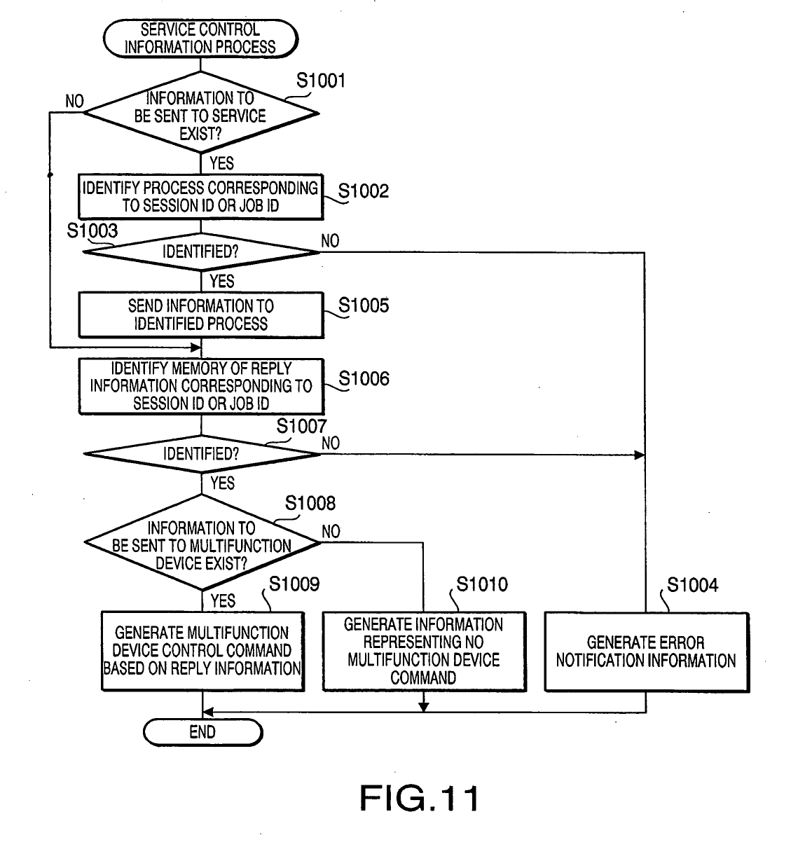

Hereafter, a function server process executed under control of the control unit 31 of the function server 30 is explained with reference to FIG. 10. When the function server process is initiated, the control unit 31 receives an HTTP request in step S901.

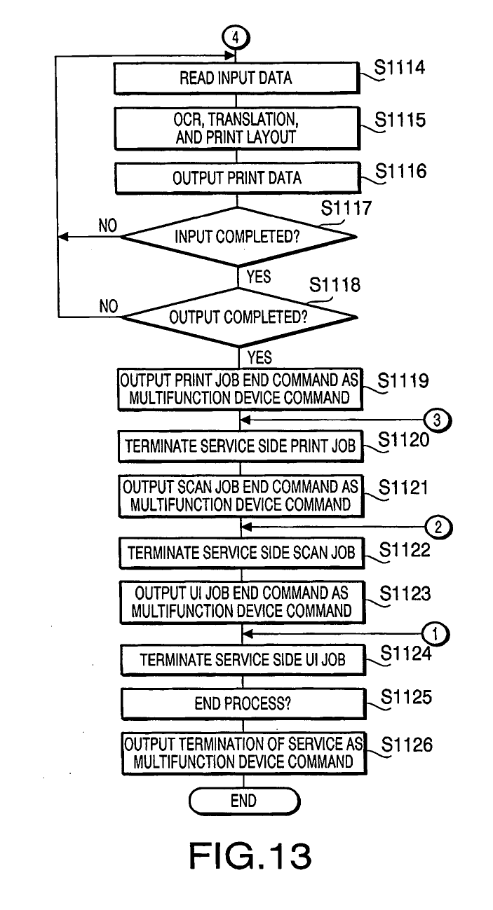

Then, the control unit 31 judges Whether the HTTP request received in step S901 represents a service initiation command. If the control unit 31 judges that the HTTP request received in step S901 represents a service initiation command (S902: YES), control proceeds to step S903 where the control unit 31 generates transmission data by generating a session ID. Further, in step S903, the control unit 31 initiates a process executing a service (i.e., a session process shown in FIG. 12). Then, control proceeds to step S907.

If the control unit 31 judges that the HTTP request received in step S901 does not represent a service initiation command (S902: NO), control proceeds to step S904 where the control unit 31 judges whether the received HTTP request represents a service end command. The service end command is transmitted by the MFD 10, for example, when the MFD 10 accepts an end command from the user of the MFD 10 as an interrupt (e.g., an interrupt made by pressing the cancel key on the display panel).

If the control unit 31 judges that the received HTTP request represents a service end command (S904: YES), control proceeds to step S905 where the control unit 31 releases the session ID and the secured resources. Then, control proceeds to step S907.

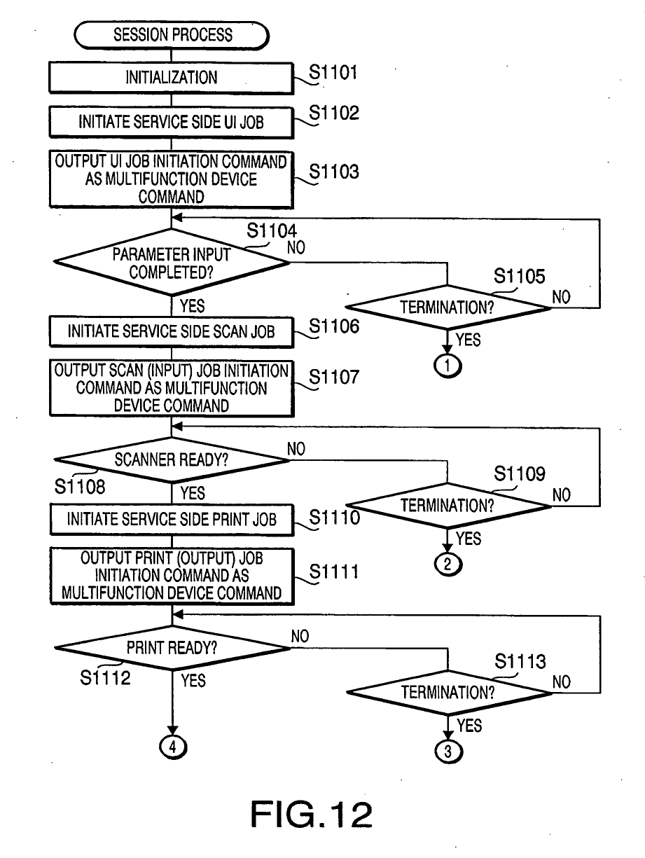

If the control unit 31 judges that the received HTTP request does not represent a service end command (S904: NO), control proceeds to step S906 where a service control information process shown in FIG. 11 is executed. Then, control proceeds to step S907. In step S907, the control unit 31 transmits a response containing the generated information.

In step S908, the control unit 31 judges whether the service control information process of step S906 has been executed. If it is judged that the service control information process has been executed (S908: YES), control proceeds to step S909 where the control unit 31 assigns “transmission completed” to a memory address corresponding to the session ID or the job ID. Then, the function server process terminates. If it is judged that the service control information process has not been executed (S909: NO), the function server process terminates.

Hereafter, the service control information process to be executed in step S906 of the function server process (FIG. 10) is explained with reference to FIG. 11.

When the service control information process is initiated, the control unit 31 judges whether information to be sent to a service exists (step S1001). More specifically, in step S1001, the control unit 31 judges whether the HTTP request received in step S901 contains information to be provided for a service (a session or a job).

If it is judged in step S1001 that information to be provided for a service exists (S1001: YES), control proceeds to step S1002 where the control unit 31 identifies a process corresponding to the session ID or the job ID. That is, the control unit 31 identifies a process which is a destination of the information contained in the received HTTP request. In step S1003, the control unit 31 judges whether a process is identified. If a process is not identified due to a certain reason (S1003: NO), control proceeds to step S1004 where the control unit 31 generates error notification information. Then, the service control information process terminates.

If a process is identified (S1003; YES), control proceeds to step S1005 where the information is sent to the identified process. Then, control proceeds to step S1006. If it is judged in step S1001 that information to be provided for a service does not exist (S1001: NO), control proceeds to step S1006.

In step S1006, the control unit 31 identifies a memory area of reply information corresponding to the session ID or the job ID. Next, in step S1007, the control unit 31 judges whether the memory area is identified.

If the control unit 31 judges that the memory area is not identified (S1007: NO), control proceeds to step S1004 where the control unit 31 generates error notification information. Then, the service control information process terminates. If the control unit 31 judges that the memory area is identified (S1007: YES), control proceeds to step S1008 where the control unit 31 judges whether information to be provided for the MFD 10 exists.

If the information to be provided for the MFD 10 exists (S1008: YES), the control unit 31 generates a multifunction device command based on the reply information (step S1009). Then, the service control information process terminates.

If the information to be provided for the MFD 10 does not exist (S1008: NO), control proceeds to step S1010 where the control unit 31 generates information indicating that there is no multifunction device command. Then, the service control information process terminates.

Hereafter, the session process initiated in step S903 of the function server process (FIG. 10) is explained with reference to FIGS. 12 and 13. The session process shown in FIG. 10 is executed under control of the control unit 31 of the function server 30. It should be noted that a configuration of the session process varies depending on a service type to be provided. In FIGS. 12 and 13, the session process configured for a service relating to a translation copy is illustrated.

When the session process is initiated, first, the control unit 31 executes an initialization process in step S1101. Next, the control unit 31 initiates a service side UI job (step S1102). Next, in step S1103, the control unit 31 outputs a UI job initiation command as a multifunction device command. More specifically, the control unit 31 writes the multifunction device command into a memory area of the reply information, and thereafter confirms that the multifunction device command is outputted by confirming that the “transmission completed” is assigned to the memory area in step S909. A job ID and a destination URL of the job are also outputted along with the UI job initiation command.

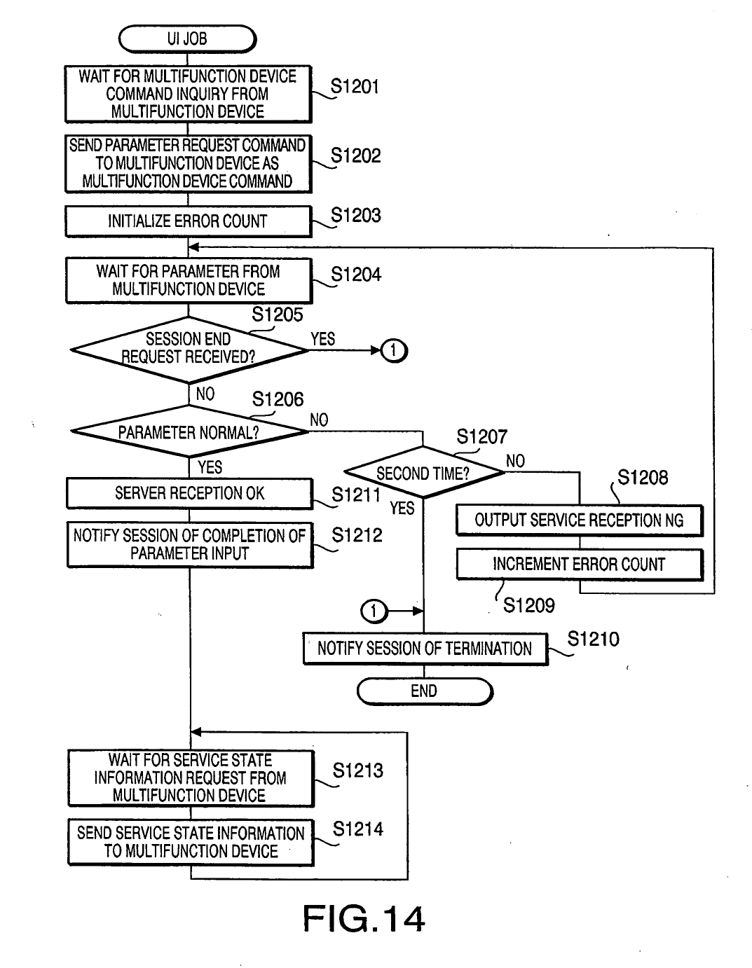

Next, in step S1104, the control unit 31 judges whether the parameter input has been finished. The control unit 31 judges whether the parameter input has been finished by judging whether a notification indicating completion of the parameter input is notified by step S1212 of a UI job (FIG. 14).

If the control unit 31 judges that the parameter input has not been finished (S1104: NO), the control unit 31 judges whether termination is notified by the UI job process shown in FIG. 14. If the termination is not notified (S1105: NO), control returns to step S1104. If the termination is notified (S105: YES), control proceeds to step S1124.

If the control unit 31 judges that the parameter input has been finished (S1104: YES), control proceeds to step S1106 where the control unit 31 initiates a service side scan job which is a job of a service relating to image data generated by the reading unit 13 of the MFD 10. next, in step S1107, the control unit 31 outputs a scan job (an input job) initiation command as a multifunction device command. A job ID and a destination of the job are also outputted along with the scan job initiation command.

Next, in step S1108, the control unit 31 judges whether preparation of a scanner has been completed. The control unit 31 may judge whether the preparation of a scanner has been completed by using a notification from the scan job. If the preparation of a scanner has been completed (S1108: NO), control proceeds to step S1109 where the control unit 31 judges whether termination has been notified by the scan job.

If the termination has not been notified by the scan job (S1109: NO), control returns to step S1108. If the termination has been notified by the scan job (S1109: YES), control proceeds to step S1122.

If the scanner is in a ready state (S1108: YES), control proceeds to step S1110 where the control unit 31 initiates a service side print job which is a job of a service relating to image data of an image to be printed out by the recording unit 14 of the MFD 10. Next, in step S1111, the control unit 31 outputs a print job (an output job) initiation command as a multifunction device command. A job ID and a destination URL of the job are also outputted along with the print job initiation command.

Next, in step S1112, the control unit 31 judges whether preparation for printing has been completed. The control unit 31 may judge whether the preparation for printing has been completed by using a notification from the print job. If the preparation for printing has not been completed (S1112: NO), control proceeds to step S1113 where termination of the print job has been notified from the print job. If the termination has not been notified from the print job (S1113: NO), control returns to step S1112. If the termination has been notified from the print job (S1113: YES), control proceeds to step S1120.

If the preparation for printing has been completed (S1112: YES), control proceeds to step 1114 where the input data (i.e., image data generated by the reading unit 13) is read out.

Next, in step S1115, the control unit 31 recognizes text contained in the image corresponding to the image data obtained in step S1114 by executing an OCR process for the image data, executes a translation process on the recognized text, and performs a print layout process for the translated text. Consequently, image data for printing is generated.

Next, in step S1116, the control unit 31 outputs the image data for printing generated in step S1115. Then, the control unit 31 judges whether the input of all of the data has been completed.

If the input of all of the data has not been completed (S1117: NO), control returns to step S1114. If the input of all of the data has been completed (S1117: YES), control proceeds to step S1118 where the control unit 31 judges whether the output of all of the data has been completed. If the output of all of the data has not been completed (S1118: NO), control proceeds to step S1114. If the output of all of the data has been completed (S1118: YES), control proceeds to step S1119 where the control unit 31 outputs a print job end command as a multifunction device command. A job ID corresponding to the print job is also outputted along with the print job end command.

Next, in step S1120, the service side print job is terminated. Then, the control unit 31 outputs a scan job end command as a multifunction device command (step S1121). A job ID corresponding to the scan job to be terminated is also outputted along with the scan job end command.

Next, in step S1122, the service side scan job is terminated. Then, the control unit 31 outputs a UI job end command as a multifunction device command (step S1123). A job ID corresponding to the UI job to be terminated is also output along with the UI job end command. Next, in step S1124, the service side UI job is terminated.

In step S1125, the control unit 31 executes an end process (e.g. release of memory). Next, the control unit 31 outputs an multifunction device command indicating termination of the service (step S1126). Then, the session process terminates.

Hereafter, a UI job process initiated in step S1102 of the session process (FIG. 12) is explained with reference to FIG. 14. When the UI job process is initiated, first, the control unit 31 receives a multifunction device command inquiry from the MFD 10 (step S1201).

Next, in step S1202, the control unit 31 transmits a parameter request command, for requesting the MFD 10 to make parameter settings necessary for execution of a service, to the MFD 10, as a multifunction device command. The service interface information 36 (e.g., the service interface information 36 corresponding to a translation copy service) stored in the storage unit 33 is also transmitted along with the parameter request command.

Next, in step S1203, the control unit 31 initializes an error count. Next, in step S1204, the control unit 31 receives the parameters from the MFD 10. Next, in step S1205, the control unit 31 judges whether a session end request is received. If the session end request is received (S1205: YES), control proceeds to step S1210.

If the session end request is not received (S1205: NO), control proceeds to step S1206 where the control unit 31 judges whether the parameters received in step S1204 are valid. If the parameters are invalid (S1206: NO), control proceeds to step S1207 where the control unit 31 judges whether the number of counts wherein the parameters are judged to be invalid reaches two.

If it is judged in step S1207 that the number of counts where the parameters are judged to be invalid has not reached two (i.e., the number count is one) (S1207: NO), control proceeds to step S1208 where the control unit 31 outputs “server reception NG” (abnormal reception) which is a notification indicating whether the function server 30 receives information from the MFD 10 normally, as a server reception status. Then, the control unit 31 increases the error count. Then, control returns to step S1204.

If it is judged in step S1207 that the number of counts where the parameters are judged to be invalid has reached two (S1207: YES), control proceeds to step S1210 where the control unit 31 notifies the session of termination. Then, the UI job process terminates.

If the parameters are valid (S1206: YES), control proceeds to step S1211 where the control unit 31 outputs “server reception OK” (normal reception) as a server reception status.

Next, in step S1212, the control unit 31 sends “parameter input completed” to the session. Next, in step S1213, the control unit 31 receives a service status information request from the MFD 10. next, in step S1214, the control unit 31 transmits service status information to the MFD 10. Then, control returns to step S1213. That is, the control unit 31 repeats receiving a multifunction device command inquiry from the MFD 10 and retuning the service status information until the UI job process is terminated by another process. An error code and the service interface information 36 are also transmitted along with the service status information.

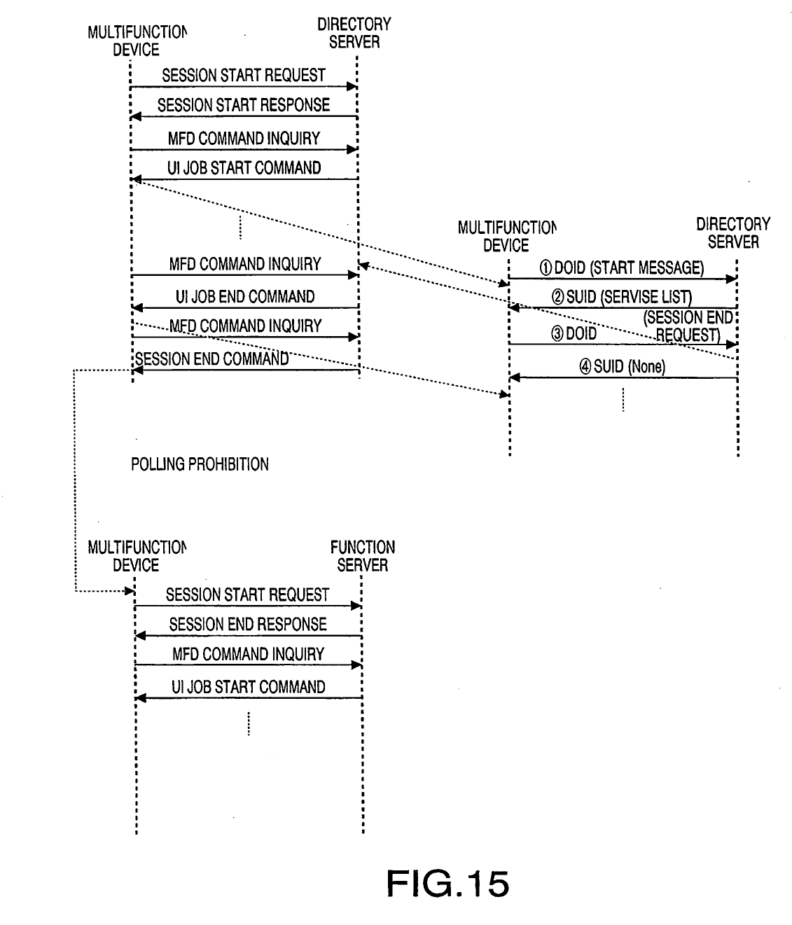

FIG. 15 is a sequence diagram of communications performed between the MFD 10 and the directory server 20 and communications performed between the MFD 10 and the function server 30. As described above, when the MFD 10 requests the directory server 20 to start a session, the directory server 20 returns a response representing initiation of a session. Then, the MFD 10 transmits a multifunction device command inquiry to the directory server 20. After receiving the multifunction device command inquiry, the directory server 20 returns a UI job initiation command as a multifunction device command.

Then, the MFD 10 initiates a UI job. After a UI job is initiated, the MFD 10 transmits a start message (DOID) to the directory server 20. Then, the directory server 20 returns a list services to the MFD 10 as a response.

In response to a selection of a service made on the MFD 10 by a user of the MFD 10, the MFD 10 prohibits polling, and transmits a session end request to the directory server 20. When the MFD 10 transmits a multifunction device command inquiry to the directory server 20, the directory server 20 returns a UI job end command to the MFD 10 as a multifunction device command.

Next, when the MFD 10 transmits a multifunction device command inquiry to the directory server 20, the directory server 20 returns a session end command to the MFD 10. Then, the MFD 10 initiates a session with the function server 30 while prohibiting polling.

As described above, in the communication system 100, the directory server 20 provides contents (service definition information 25) corresponding to a request signal (a service initiation command) from the MFD 10, for the MFD 10, while the MFD 10 prohibits requests for contents other than related contents from being issued from the MFD 10 when the MFD 10 has requested the related contents (e.g. image data of translated text). That is, the MFD 10 restricts requests to be issued to those for the related contents.

Therefore, according to the present invention, when the user of the MFD 10 has requested related contents, the MFD 10 is able to prevent contents other than the related contents from being received by the MFD 10. Therefore, the MFD 10 is able to continue to receive the related contents without being interrupted by reception of contents other than the related contents.

Although the present invention has been described in considerable detail with reference to certain exemplary embodiments thereof, other embodiments are possible.

For example, an information management server having a function of managing presence or absence of contents to be received by the MFD 10 can be added to the communication system 100. In this case, the MFD 10 is configured to execute polling for the information management server.

In the above mentioned embodiment, the directory server 20 and the function server 30 are provided as separate servers. However, the functions of the directory server 20 and the function server 30 can be integrated in a single device (i.e., an information providing device).

What is claimed is:

1. A communication system in which an information providing server and an information processing device are connected to each other via a network,
wherein the information providing server comprises:
a request reception unit to receive a request for contents from the information processing device;
a content transmission unit to transmit contents corresponding to the received request to the information processing device; and
an information addition unit configured such that, if related contents relating to the contents to be transmitted by the content transmission unit exist, the information addition unit adds addition information representing presence of the related contents, to the contents to be transmitted by the content transmission unit,
wherein the information processing device comprises:
a request transmission unit to transmit the request for contents to the information providing server;
a content reception unit to receive contents transmitted from the information providing server as a response to the request;
an addition judgment unit to judge whether the addition information is added to the contents received by the content reception unit; and
a restriction unit to restrict a request to be transmitted by the request transmission unit to request types requesting contents relating to the related contents if the addition judgment unit judges that the addition information is added to the contents from the information providing server.

2. The communication system according claim 1, wherein the restriction unit prohibits requests for contents not relating to the related contents from being transmitted by the request transmission unit.

3. The communication system according to claim 1,
wherein the information processing device comprises a selection unit to select whether to cause the restriction unit to prohibit requests for contents not relating to the related contents from being transmitted if the addition judgment unit judges that the addition information is added to the contents from the information providing server,
wherein the restriction unit restricts a request to be transmitted by the request transmission unit to request types requesting contents relating to the related contents.

4. The communication system according to claim 1, wherein:
the addition information includes address information representing an address of the information providing server which transmits the related contents; and
the restriction unit restricts a destination of the request transmitted by the request transmission unit to the address represented by the address information.

5. A communication system in which an information providing server and an information processing device are connected to each other via a network,
wherein the information providing server comprises:
a request reception unit to receive a request for contents from the information processing device;
a content transmission unit to transmit contents corresponding to the received request to the information processing device; and
an information addition unit configured such that, if related contents relating to the contents to be transmitted by the content transmission unit exist, the information addition unit adds addition information, representing presence of the related contents, to the contents to be transmitted by the content transmission unit,
wherein the information processing device comprises:
a request transmission unit to transmit the request for contents to the information providing server;
a content reception unit to receive contents transmitted from the information providing server as a response to the request;
an addition judgment unit to judge whether the addition information is added to the contents received by the content reception unit; and
a restriction unit to prohibit requests for contents not relating to the related contents from being transmitted by the request transmission unit if the addition judgment unit judges that the addition information is added to the contents from the information providing server.

6. The communication system according to claim 5,
wherein the information processing device comprises a selection unit to select whether to cause the restriction unit to prohibit requests for contents not relating to the related contents from being transmitted if the addition judgment unit judges that the addition information is added to the contents from the information providing server,
wherein the restriction unit restricts a request to be transmitted by the request transmission unit to request types requesting contents relating to the related contents.

7. The communication system according to claim 5, wherein:
the addition information includes address information representing an address of the information providing server which transmits the related contents; and
the restriction unit restricts a destination of the request transmitted by the request transmission unit to the address represented by the address information.

8. An information processing device for receiving contents from an information providing server, comprising:
a request transmission unit to transmit a request for contents to the information providing server;
a content reception to receive contents transmitted from the information providing server as a response to the request;
an addition judgment unit to judge whether addition information representing presence of related contents relating to the contents to be transmitted by the information providing server is added to the contents received by the content reception unit; and
a restriction unit to restrict a request to be transmitted by the request transmission unit to request types requesting contents relating to the related contents if the addition judgment unit judges that the addition information is added to the contents from the information providing server.

9. An information processing device for receiving contents from an information providing server, comprising:
a request transmission unit to transmit a request for contents to the information providing server;
a content reception unit to receive contents transmitted from the information providing server as a response to the request;
an addition judgment unit to judge whether addition information representing presence of related contents relating to the contents to be transmitted by the information providing server is added to the contents received by the content reception unit; and
a restriction unit to prohibit requests for contents not relating to the related contents from being transmitted by the request transmission unit if the addition judgment unit judges that the addition information is added to the contents from the information providing server.

10. An information providing server for transmitting contents to an information processing device, comprising:
a request reception unit to receive a request for contents from the information processing device;
a content transmission unit to transmit contents corresponding to the received request; and
an information addition unit configured such that, if related contents relating to the contents to be transmitted by the content transmission unit exist, the information addition unit adds addition information, representing presence of the related contents, to the contents to be transmitted by the content transmission unit.

11. A computer readable medium comprising computer readable instructions to be executed by a computer, functioning as an information processing device for receiving contents from an information providing server, the instructions causing the computer to:
transmit a request for contents to the information providing server;
receive contents transmitted from the information providing server as a response to the request;
judge whether addition information representing presence of related contents, relating to the contents to be transmitted by the information providing server, is added to the contents; and
restrict a request to be transmitted to request types requesting contents relating to the related contents if it is judged that the addition information is added to the contents from the information providing server.

12. A computer readable medium comprising computer readable instructions to be executed by a computer, functioning as an information processing device for receiving contents from an information providing server, the instructions causing the computer to:
transmit a request for contents to the information providing server;
receive contents transmitted from the information providing server as a response to the request;
judge whether addition information, representing presence of related contents relating to the contents to be transmitted by the information providing server, is added to the contents; and
prohibit requests for contents not relating to the related contents from being transmitted if it is judged that the addition information is added to the contents from the information providing server.

13. A computer readable medium comprising computer readable instructions to be executed by a computer, functioning as an information providing server for transmitting contents to an information processing device, the instructions causing the computer to:
receive a request for contents from the information processing device;
transmit contents corresponding to the received request to the information processing device; and
add addition information representing presence of related contents relating to the contents to be transmitted to the contents if the related contents relating to the contents to be transmitted exist.
